(19) United States
(12) Patent Application Publication
(10) Pub. No.: US 2009/0035057 A1
(43) Pub. Date: Feb. 5, 2009

(54) FLANGELESS DEMOUNTABLE PIN SYSTEM

(76) Inventor: Victor L. CHUN, Walton Hills, OH (US)

Correspondence Address: SCHNADER HARRISON SEGAL & LEWIS, LLP, 1600 MARKET STREET, SUITE 3600, PHILADELPHIA, PA, 19103, US

(21) Appl. No.: 12/171,097

(22) Filed: Jul. 10, 2008

Related U.S. Application Data
(63) Continuation-in-part of application No. 12/109,607, filed on Apr. 25, 2008.
(60) Provisional application No. 60/949,407, filed on Jul. 12, 2007.

(51) Int. Cl. F16D 1/00; B21K 27/06; B23P 11/00

(52) U.S. Cl. 403/365; 72/324; 29/428

(57) ABSTRACT

An article of manufacture comprises a demountable pin or bushing element having a generally cylindrical shape and a main section having a main diameter and a circumferential groove. Assembled within the groove is a plurality of retainer pieces. The inner diameter section of each retainer piece is matable to the groove diameter such that the retainer piece protrudes from the groove. Each retainer piece has at least one axially oriented mounting hole. Also disclosed is a method of manufacturing to order demountable pin or bushing elements employing the article of manufacture.

This application is a continuation in part of U.S. application Ser. No. 12/109,607, filed Apr. 25, 2008. In addition, this application claims the priority of U.S. provisional patent application No. 60/949,407, filed Jul. 12, 2007.

The following disclosures are incorporated by reference into this application: U.S. application Ser. No. 12/109,607; U.S. application Ser. No. 11/223,134, filed Sep. 9, 2005; and U.S. provisional patent application No. 60/949,407.

### FIELD OF THE INVENTION

This invention concerns guide pins and bushings used in the construction of forming dies.

### BACKGROUND OF THE INVENTION

Forming dies are comprised of two die parts, respectively mounted to an upper and a lower press platen. A guide pin or post is mounted to one die part, and a guide bushing is mounted to the other die part in alignment with the pin. The pin and bushing mate with each other when the press is actuated to guide the die parts into accurate registry. Such pins and posts may be press fit into holes in the respective die parts, but this makes disassembly for repairs difficult. To address this difficulty, so-called “demountable” pins and bushings have been developed, in which the pin and bushing are slidably fit in the die bases and are held with clamps engaging a flange on the pin or bushing, pressing the same against the adjacent die-part surface. The die-part surface is ground so that the pin and bushing are thereby precisely aligned with each other.

The flange has conventionally been formed by machining down large-diameter stock to form the pin or bushing, thereby producing much wasted material and increasing the time necessary to produce the pin or bushing. It thus has been necessary to manufacture and stock pins and bushings so as to achieve reasonably rapid delivery times. Stocking pins and bushings substantially increases costs because many configurations and sizes of pins and bushings must be stocked in order to be available for delivery on short notice.

It is an object of the present invention to provide guide pins and bushings and a method of manufacturing guide pins and bushings to a customer order. The method allows pins and bushings to be made rapidly to order while eliminating the need to waste time and material in machining the pins to form an integral flange. The method also reduces or eliminates the need to stock a large number of different pins and bushings.

### SUMMARY OF THE INVENTION

The above object, and other objects that will become apparent upon a reading of the following specification and claims, are achieved by stocking lengths of standard-diameter shafts and tubes that have been heat-treated and precision-ground to a finished inside or outside diameter. When an order is received, a shaft or tube of the desired diameter is cut to length and machined to form a circumferential groove therein. Retainer pieces are engaged into the groove and provide axial mounting holes that may be used to secure the pin or bushing to a die plate. In this manner the same pin can be installed in a slip fit to the die plate, and thus is easily demountable; or the pin can be pressed into a die plate for maximum rigidity. Each retainer piece is assembled onto the pin or bushing at a specified location in such a way as to perform the retention function traditionally performed by an integral flange.

In one embodiment of the invention, a groove at the desired location of the flange is machined into the outside diameter of the pin or bushing. A plurality of retainer pieces is provided, each piece with an inner diameter section having a substantially uniform inner diameter, and having at least one axially oriented hole passing therethrough. Each retainer piece is engagable in the groove to secure the retainer piece in the groove. The inner diameter of the inner diameter section of retainer piece is matable to the groove diameter, and once engaged, the retainer piece protrudes from the circumferential groove sufficiently to permit at least one mounting hole to be used for securing the pin or bushing element to a die plate.

The invention also includes a method of manufacturing a pin or bushing, the method comprising the following steps: providing stock for a pin or bushing element as described above; forming or cutting the stock to a desired length; machining a circumferential groove into the stock; providing one or more retainer pieces as described above; and assembling the retainer pieces into the groove of the pin or bushing element.

Embodiments of the invention can reduce the cost of a demountable pin and yet provide maximum holding power of the pin to the die plate. This is achieved by having the same pin for demountable or pressed fit condition, thus reducing the cost of producing the pins and reducing inventory of finished goods. This is complemented by having retainers that are easily producible to be precise and strong. This new invention is easier to produce compared to the assembled flanges in U.S. patent application Ser. No. 11/223,134, which are superior to a conventional pin with the conventional integral flange. In the cited patent application, a flange is created in a pin or bushing by press fitting inner split taper ring pieces into the groove in the pin and using an outer taper ring. The groove in the pin, the split taper ring pieces, and the outer taper ring all need a high level of dimensional precision in order to have a good, controlled, tight fit when assembled. This high level of precision is not necessary for the successful use of the invention described in this new disclosure.

In the “Volvo” pin cited as a reference in the cited patent application, the contact of the round ring to the inner edge of the hole in the die plate produces very high stress concentration which could deform the hole in the plate, resulting in too much tightness to the pin and making it more difficult to demount the pin. The retaining bracket needs to be much thicker in order to have sufficient material and strength in the region wrapping over the ring, otherwise it will compromise the holding force capacity.

### DESCRIPTION OF THE DRAWINGS

The invention is best understood from the following detailed description when read with the accompanying drawings.

FIG. 1 shows a side view of a guide pin machined in preparation for installing retainer pieces in a groove thereof according to an exemplary embodiment of the invention.

FIG. 2 is an isometric view of a retainer piece according to an exemplary embodiment of the invention.

FIG. 3 is an isometric view of a retainer piece according to an alternative exemplary embodiment of the invention.

FIG. 4 is a sectional view of a guide pin with retainer pieces assembled in the groove thereof according to an exemplary embodiment of the invention.

FIG. 5 is a sectional view of a guide pin with retainer pieces assembled in the groove thereof according to an alternative exemplary embodiment of the invention.

FIG. 6 is a sectional view of a guide pin with annular retainer pieces assembled in the groove thereof according to an alternative exemplary embodiment of the invention, shown attached to a die platen.

FIG. 7 shows a perspective view of a guide pin with retainer pieces installed in the groove thereof according to an exemplary embodiment of the invention.

FIG. 8 shows a perspective view of a guide pin with retainer pieces installed in the groove thereof according to an alternative exemplary embodiment of the invention.

FIG. 9 shows a side view of a guide pin according to an alternative exemplary embodiment of the invention.

### DETAILED DESCRIPTION OF THE INVENTION

In the following detailed description, certain specific terminology will be employed for the sake of clarity and a particular embodiment described in accordance with the requirements of 35 USC 112, but it is to be understood that the same is not intended to be limiting. The invention is capable of taking many forms and variations within the scope of the appended claims.

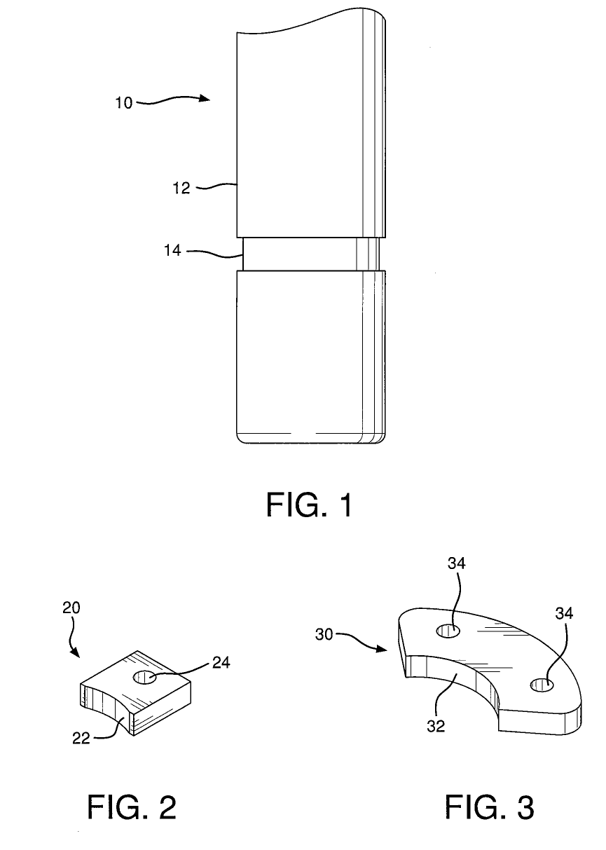

Referring to FIG. 1, a demountable element 10 is shown, here comprised of a pin 10, which has major diameter section 12 and circumferential groove 14.

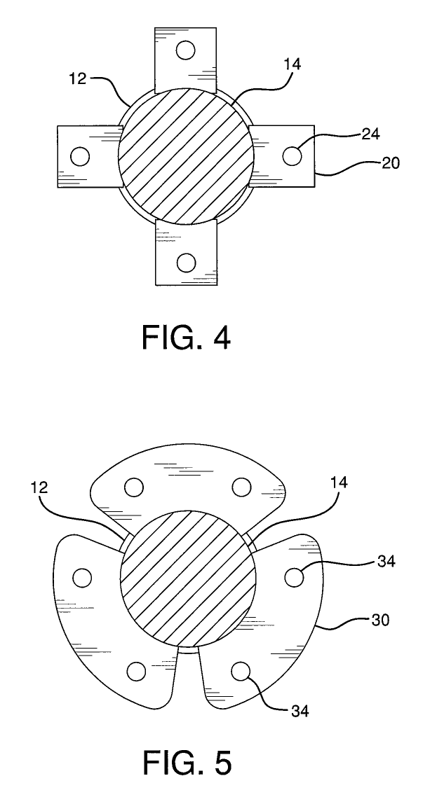

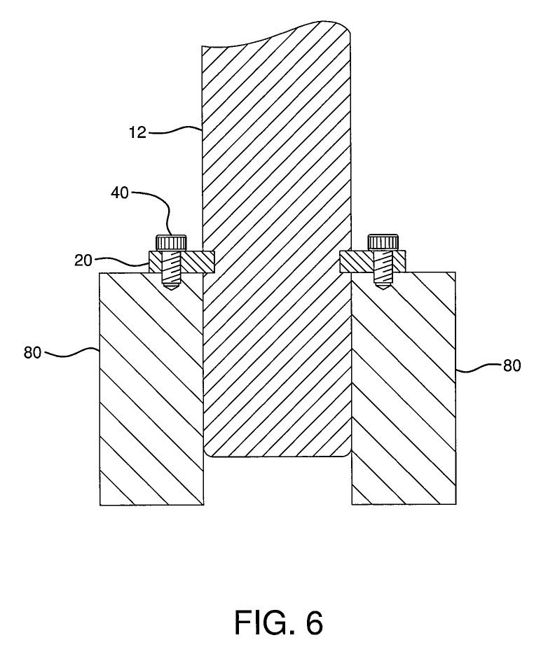

FIG. 2 shows retainer 20, which has inner surface 22 and mounting hole 24. Inner surface 22 is matable with the diameter of groove 14, preferably by having a curvature that matches the diameter of groove 14.

FIG. 3 shows alternative retainer 30, which has inner surface 32 and two mounting holes 34. Inner surface 32 is matable with the diameter of groove 14, preferably by having a curvature that matches the diameter of groove 14.

FIG. 4 shows pin 10 with major diameter section 12 and groove 14, with retainers 20 mounted in the groove. The retainers 20 are press fit into the groove 14 and provide mounting holes 24.

FIG. 5 shows pin 10 with major diameter section 12 and groove 14, with retainers 30 mounted in the groove providing mounting holes 34.

FIG. 6 shows pin 10 with major diameter section 12 and groove 14, with retainers 20 mounted in the groove and mounting bolts 40 in the mounting holes of retainers 20. Mounting bolts 40 engage die platen 80.

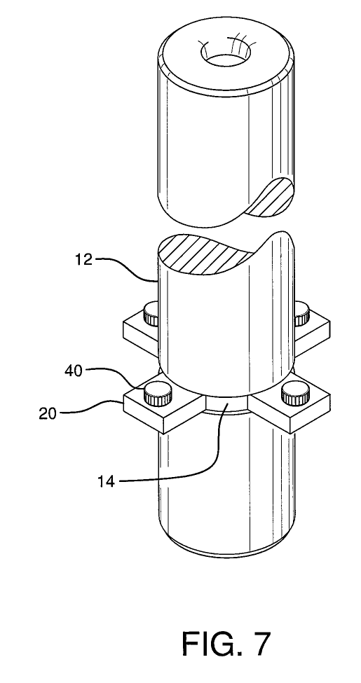

FIG. 7 shows pin 10 with major diameter section 12 and groove 14, with retainers 30 mounted in the groove and mounting bolts 40 in the mounting holes of retainers 30.

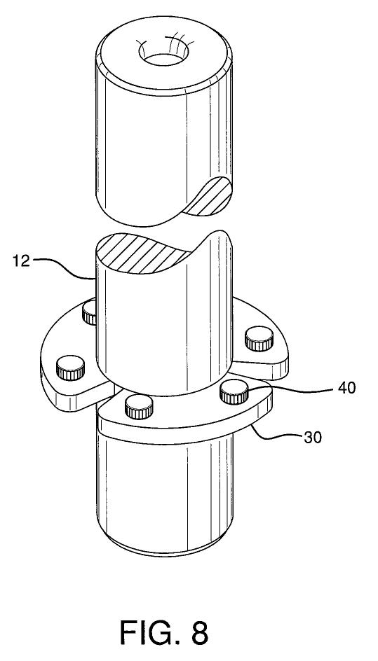

FIG. 8 shows pin 10 with major diameter section 12 and groove 14, with retainers 30 mounted in the groove and mounting bolts 40 in the mounting holes of retainers 30.

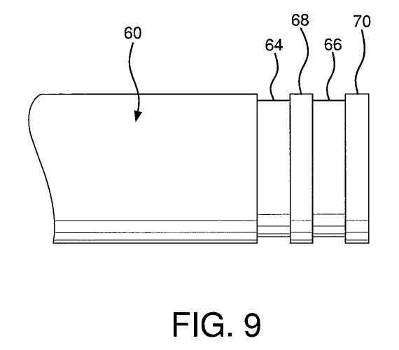

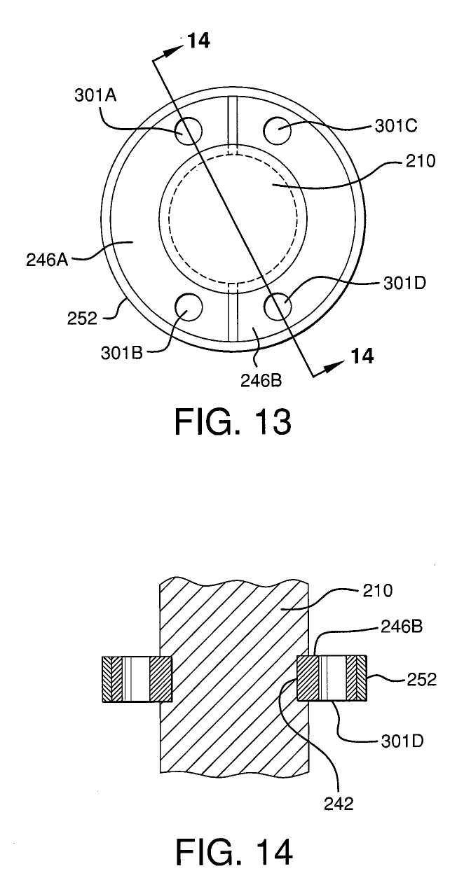

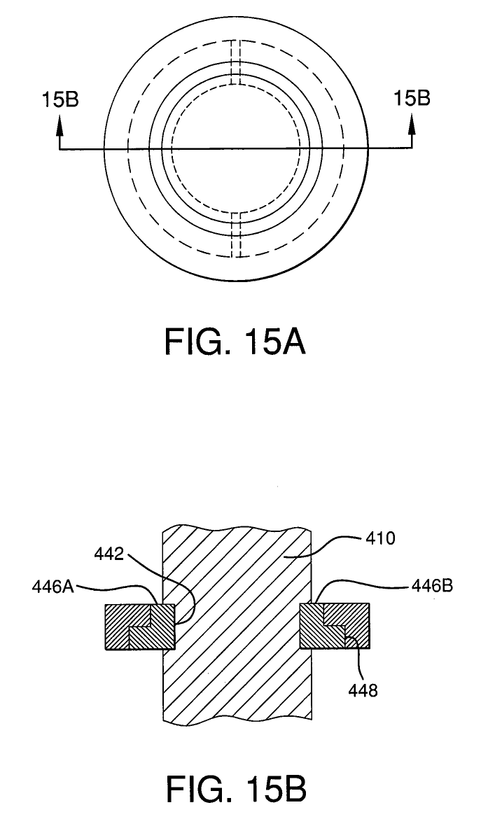

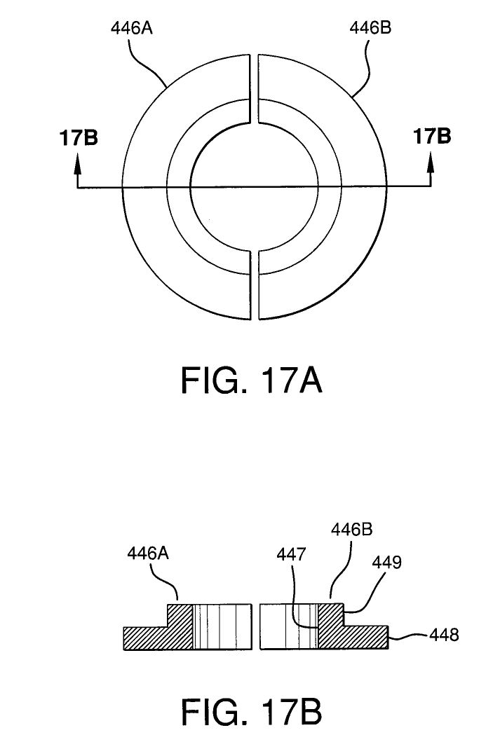

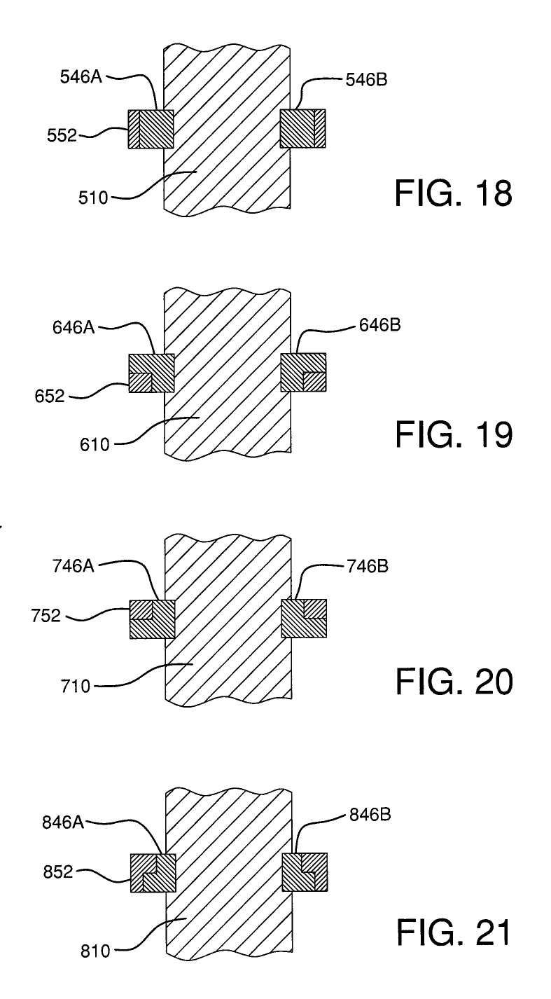

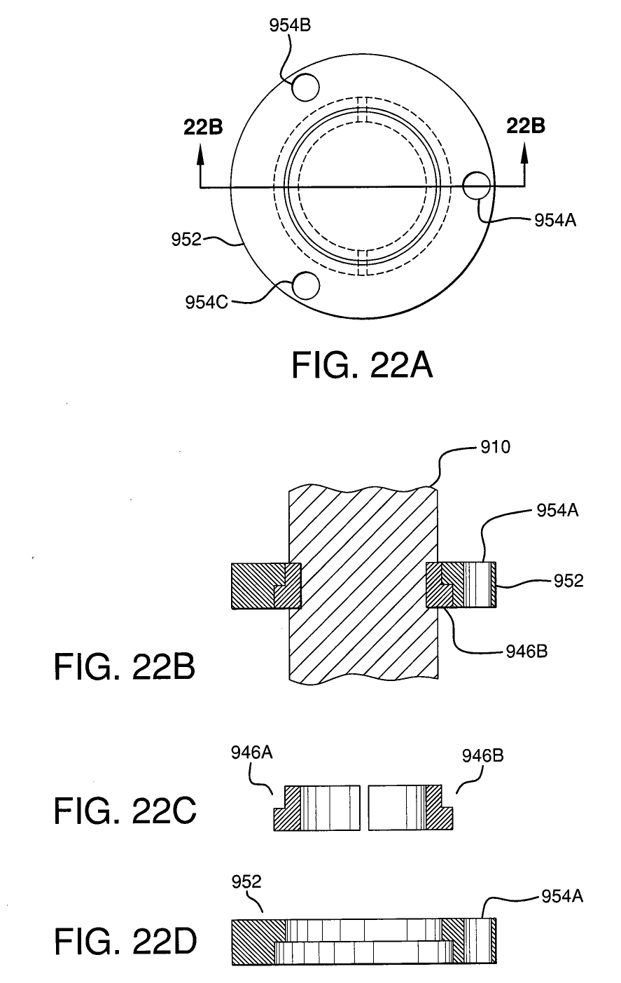

FIG. 9 shows an alternative demountable pin 60, which has major diameter section 62, groove 64, and secondary groove 66, which is located near one end of pin 60 and preferably near groove 64. Secondary groove 66 has adjacent thereto intermediate segment 68 and end segment 70. Intermediate segment 68 and end segment 70 have a common diameter adapted for mating with a hole when the pin is in use. For ease of manufacturing, the common diameter of segments 68 and 70 preferably is the same as the main diameter of the demountable pin 60. Segments 68 and 70 enhance the stability of the pin 60 when mounted in the hole, and secondary groove 66 reduces frictional drag when the demountable pin 37 is being installed into the hole.

Preferably the demountable pins and bushings and the retainer pieces are heat treated to a high hardness and strength.

The invention includes a manufacturing method that allows pin and bushing elements to be conveniently manufactured to order. One embodiment of the method includes the following steps: (a) stocking lengths of a series of machined cylindrical stock; (b) cutting the stock to form a rough element of having an ordered length and a main diameter section having a main diameter; (c) machining the rough element to create a circumferential groove in the main section, the circumferential groove having a diameter less than the main diameter; (d) providing a plurality of annular retainer pieces with an inner diameter section having a substantially uniform inner diameter, each annular retainer piece such that the retainer protrudes from the circumferential groove; and (e) assembling the retainer pieces around and within the groove. Any necessary machining operations can be added to this manufacturing method at an appropriate point before or after assembly of the flange. For example, any necessary counterbore may be machined before or after undertaking the steps of the exemplary manufacturing method of the invention.

While the invention has been described by illustrative embodiments, additional advantages and modifications will occur to those skilled in the art. Therefore, the invention in its broader aspects is not limited to specific details shown and described herein. Modifications may be made without departing from the spirit and scope of the invention. For example, retainers having a different number of axial mounting holes may be provided. Accordingly, it is intended that the invention not be limited to the specific illustrative embodiments, but be interpreted within the full spirit and scope of the appended claims and their equivalents.

What is claimed is:

1. An article of manufacture comprising:
a flanged demountable pin or bushing element having a generally cylindrical shape, the element having a main section having a main diameter, and the element having a circumferential groove in the main section, the circumferential groove having a diameter less than the main diameter;
a plurality of retainer pieces with an inner diameter section having a substantially uniform inner diameter, each annular retainer piece having at least one axially oriented mounting hole passing therethrough, the inner diameter of the inner diameter section of each annular retainer piece being matable to the groove diameter, each annular retainer piece being engagable in the groove to secure the annular retainer piece, each annular retainer piece protruding from the circumferential groove sufficiently to permit at least one mounting hole thereof to be used for securing the element to a die plate.

2. An article of manufacture according to claim 1 wherein at least one retainer piece has two axially oriented mounting holes passing therethrough.

3. An article of manufacture according to claim 1 wherein at least one retainer piece is heat-treated.

4. An article of manufacture according to claim 1 further comprising a die plate and at least one bolt passing through a mounting hole of a retainer piece and thereby fastening the die plate to the element.

5. An article of manufacture according to claim 1, wherein the element has a main section having a main diameter, a circumferential groove in the main section, and a secondary circumferential groove in the main section, wherein the circumferential groove has a diameter less than the main diameter and the secondary circumferential groove has a diameter less than the main diameter, and wherein the annular retainer pieces are assembled around and within the circumferential groove.

6. An article of manufacture according to claim 1, wherein the element has a first end, a second end, and a main section having a main diameter, and wherein the circumferential groove is located a distance from the first end, and wherein the element has a secondary circumferential groove located between the circumferential groove and the first end so as to form an intermediate segment located between the circumferential groove and the secondary circumferential groove and an end segment located adjacent the first end of the element, and wherein the annular retainer pieces are assembled around and within the circumferential groove.

7. A method of fabricating a demountable pin or bushing element comprising:
forming a pin or bushing element;
forming a circumferential groove in the element;
forming a plurality of retainers engagable with the pin such that a desired surface contact and holding power are achieved;
engaging the retainers in the circumferential groove.

8. The method of claim 7 wherein the circumferential groove is formed in the pin contemporaneously with the formation of the pin.

9. The method of claim 7 wherein the circumferential groove is formed in the pin subsequent to formation of the pin.

10. The method of claim 7 further comprising heat-treating the pin.

11. The method of claim 7 further comprising heat-treating one or more of the retainers.

12. A method of installing a demountable pin or bushing element comprising
providing a pin with a circumferential groove;
providing at least one retainer having at least one axially oriented mounting hole and engagable with the element;
providing at least one fastener capable of passing through the mounting hole;
passing the fastener through the mounting hole; and
engaging the fastener to a die plate to secure the die plate to the element;
wherein the pin and retainers are selected based on necessary surface contact and loading power of the element.

13. The method of claim 12 at least one retainer has at least two axially oriented mounting holes.

14. A method of manufacturing comprising:
stocking lengths of a series of machined cylindrical stock;
cutting the stock to form a rough element of having an ordered length and a main diameter section having a main diameter;
machining the rough element to create a circumferential groove in the main section, the circumferential groove having a diameter less than the main diameter;
providing at least one retainer piece with an inner diameter section having a substantially uniform inner diameter, each retainer piece having at least one axially oriented mounting hole passing therethrough, the inner diameter of the inner diameter section of each annular retainer piece being matable to the groove diameter, each annular retainer piece being engagable in the groove to secure the retainer piece, each retainer piece protruding from the circumferential groove sufficiently to permit a mounting hole thereof to be used for securing the element to a die plate.

15. The method according to claim 14 wherein the retainer pieces are previously manufactured and stocked for standard diameter elements.
